(19) United States
(12) Patent Application Publication
(10) Pub. No.: US 2009/0188751 A1
(43) Pub. Date: Jul. 30, 2009

(54) FALL PROTECTION DEVICE

(76) Inventor: Virgil Douglas Gilliam, West Chester, OH (US)

Correspondence Address: WOOD, HERRON & EVANS, LLP, 2700 CAREW TOWER, 441 VINE STREET, CINCINNATI, OH, 45202, US

(21) Appl. No.: 12/021,816

(22) Filed: Jan. 29, 2008

(51) Int. Cl. E04G 5/06; F16M 13/02; E04G 21/32

(52) U.S. Cl. 182/112; 248/219.4

(57) ABSTRACT

A fall protection device for protecting a person from a fall from a surface includes a lower saddle and an upper saddle configured for coupling to a column, the lower and upper saddles include tongues projecting from sides thereof. An aperture is formed in the tongue of the upper saddle and the lower saddle includes a stop structure. An elongated safety post is configured for removably engaging the saddles so the lower end of the post rests against the stop structure. A tie-off structure is mounted on the upper end of the post. The tie-off structure is configured to rotate around the upper end of the post, and includes a platform portion for supporting a restraining device coupled to a worker.

### FIELD OF THE INVENTION

The invention relates to a safety device, and more particularly to a fall protection device that is used on an elevated work surface.

### BACKGROUND OF THE INVENTION

In building construction, it is often necessary for workers to work at locations in or on a building that are elevated above the ground level. As may be appreciated, there is an inherent danger in working at an elevated position, due to the possibility of an inadvertent fall and injury to the worker. Therefore, precautions are often taken at construction sites to reduce or minimize the potential of an accident involving a worker slipping or falling from their elevated work site, and to minimize injuries to the workers, if such an accident does occur. In fact, the Occupational Safety Health Administration (OSHA) has a number of regulations associated with securing and protecting elevated workers or at a job site.

Some such regulations require that an elevated worker be secured by a line to catch and suspend them should they fall from the surface they are standing on. The line must be fixed to a secure anchor point or tie-off point, so that it will hold and support the weight of the worker. The other end of the line is usually secured to the worker, such as with a harness. To provide such protection, and to also maintain mobility for the worker, retractable reels are often used, and allow the worker to pull out or feed out a safety line or tether to allow them to access the workspace around their tie-off point.

To further prevent injury in the case of a fall, regulations associated with the tie-off point for a worker require that the tie-off point be located above the elevated work surface on which the worker is located. Usually, as the building is constructed, and the worker, and work surface are not yet located at the top of the building or at the roof level, the tie-off point may be located at a sufficient distance above the work surface. In such a case, the structures of the building provide suitable tie-off points above the work surface.

For example, with a fabricated steel building, a series of columns holds up roof girders and bar joists, and such structures that might be used as tie-off points for the work areas below the roof level. However, this scenario changes at the roof level. Generally, when the building is nearing completion, it is necessary for workers to work on the roof or at roof level, securing the roof decking or other roofing material. As may be appreciated, in a typical building construction, there is no structure above the roof. Thus, there are no elevated tie-off points for a worker putting down or welding the roof decking. Thus, it becomes difficult to comply with the appropriate safety regulations on the building roof. Generally, this is the most elevated level of the job, and thus, it is the work location best served by the safety regulations.

As a result, workers have made attempts to secure their safety harness reels in other fashions. In one scenario, they bolt or screw a plate or other structure directly to the roof decking to act as the tie-off point. Not only is such a tie-off point not elevated as required, but also, the tie-off point is not particularly sturdy. Roof decking is somewhat thin (e.g. 22 gauge), and therefore, screwing structures directly into the decking is suspect in its ability to hold a falling worker.

One possible solution that has also been utilized is to incorporate steel columns that extend above the roof level. However, these are undesirable as they ruin the aesthetics of the building, and are difficult to hide in the final construction, as they stick out of the roofline significantly. Furthermore, because of the limited reach of the retractable safety harness reels, multiple extended columns would be required in such a system as the worker has to move the reel between tie-off points, as he moves around on the job on the roof surface.

Accordingly, there is a need to address these safety issues in the prior art. There is also a need to safely secure elevated workers, even when working at roof level.

### SUMMARY OF THE INVENTION

A fall protection device for protecting a person from a fall from a surface includes a lower saddle and an upper saddle configured for coupling to a column. Each of the saddles includes a tongue projecting from a side thereof. The upper saddle includes an aperture formed in the respective tongue. In the lower saddle, in one embodiment, an aperture is formed, and a stop wall sits below the tongue. In another embodiment, the tongue holds a sleeve structure. An elongated safety post is configured for removably engaging the saddles by passing through the aperture of the upper saddle so the lower end of the post rests against the lower saddle. A tie-off structure is mounted on the upper end of the post. The tie-off structure is configured to rotate around the upper end of the post, and includes a platform portion for supporting a restraining device coupled to a worker and an anchor structure to anchor a restraining device.

These and other advantages will be apparent in light of the following figures and detailed description.

### BRIEF DESCRIPTION OF THE DRAWINGS

The accompanying drawings, which are incorporated in and constitute a part of this specification, illustrate embodiments of the invention and, together with a general description of the invention given above and the detailed description of the embodiments given below, serve to explain the principles of the invention;

FIG. 1 is a diagrammatic illustration of a fall protection device consistent with an embodiment of the invention;

FIGS. 1A and 1B are exploded and side views of lower saddles of an embodiment of the invention.

FIG. 2 is an exploded view of lower and upper saddles in accordance with the invention of FIG. 1;

FIG. 3 is an exploded view of lower and upper saddles in accordance with another embodiment of the invention;

FIG. 4 is an exploded view of lower and upper saddles in accordance with another embodiment of the invention;

FIG. 5 is an exploded view of lower and upper saddles in accordance with another embodiment of the invention;

FIG. 6 is a diagrammatic illustration of a fall protection device in accordance with another embodiment of the invention; and

FIG. 7 is a diagrammatic illustration of a fall protection device in accordance with still another embodiment of the invention.

### DETAILED DESCRIPTION OF EMBODIMENTS OF THE INVENTION

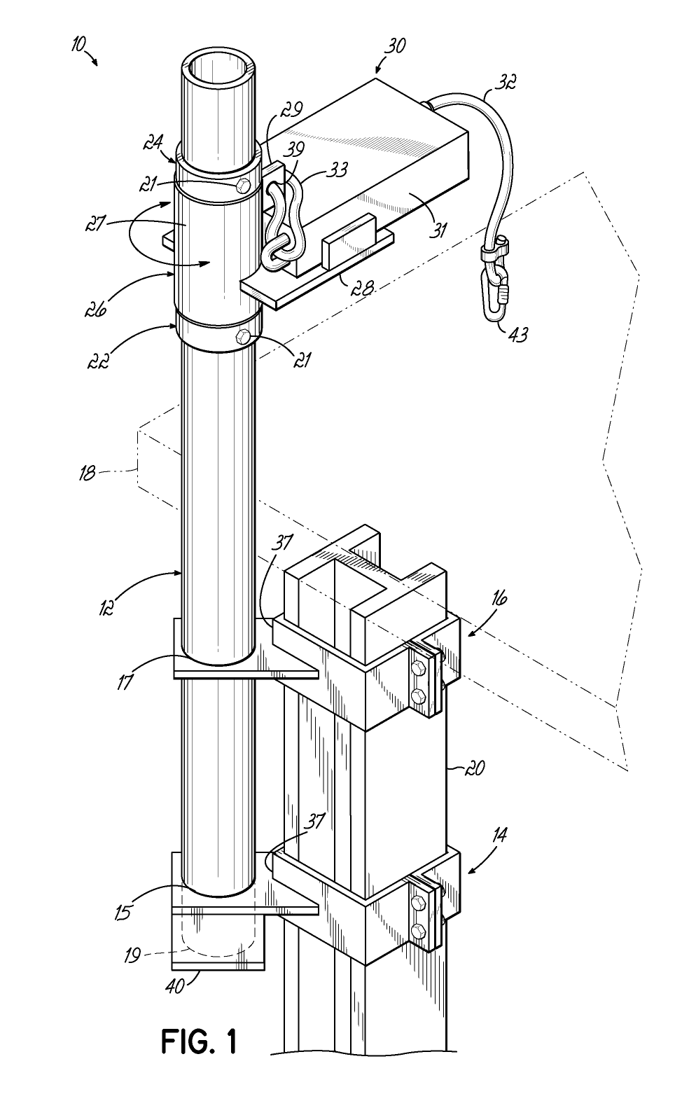

Turning to the drawings, wherein like numbers denote like parts throughout the several views, FIG. 1 is an illustrative view of a fall protection device, or apparatus, 10 consistent with an embodiment of the invention. In one embodiment, the fall protection device (“device”) 10 generally comprises an elongated safety post or pole 10 supported by a lower support structure, or saddle 14 and supported and stabilized by an upper support structure, or saddle 16. Generally, the lower saddle 14 and upper saddle 16 are positioned below the top of a work surface 18 (shown in phantom) that may be a building roof, or other elevated work surface. As may be appreciated, the work surface may take any particular form, and the invention operates to provide a suitable tie-off point located above the elevated work surface 18.

The work surface 18, such as a roof surface or roof decking, is shown supported at the top of a support column 20. It will be understood that a surface 18 like roof decking will also be supported by other structures, such as girders and bar joists (not shown). The upper and lower saddles are supported by column 20 below the level of the elevated surface 18. In that way, as discussed further below, there is no support structure constructed permanently above the roofline. In the application, H-beam type columns are shown. However, the invention works equally well with solid, square columns or round columns.

The safety post or pole 12 is removably positioned to removably engage the saddles 14, 16. For example, in the embodiment of FIG. 1, the safety post 12 extends through openings or apertures 15, 17 that are part of the saddles 14, 16, respectively. The post 12 extends through aperture 17 in upper saddle 16, and the lower end 19 of post 12 extends through aperture 15, and rests in or on the saddle 14, as shown in FIG. 1. The post might be any suitable length to provide a tie-off point above surface 18, for example 6-8 feet long. Longer or shorter posts may be used, depending on regulations or other factors involved at the work site. When the saddles are positioned at the top of the column 12 and near work surface (e.g., the roof decking) 18, and the post 12 is placed in the saddles 14, 16, the upper end 21 of the post 12 is positioned above the surface 18. This thus provides a temporary elevated structure for location of a tie-off point for a worker that might be working installing roof decking, or doing other work on or around surface 18.

Above the work surface 18, a tie-off structure is mounted. In one embodiment, as illustrated in FIG. 1, the tie-off structure 26 is secured by as a lower collar support or collar 22 and an upper collar support, or collar 24, are secured with the post 12. The collar supports 22, 24 are configured to have a cross-section substantially corresponding to the cross-section of post 12, and have a diameter slightly larger than the diameter of the post to slide on and be secured to the post.

A rotatable tie-off structure 26, such as for a restraining device 30 is positioned between the lower collar 22 and upper collar 24, and may be slid onto the pole after the lower collar 22 has been installed. The tie-off structure 26 is configured and dimensioned to freely rotate about the post 12. Typically, the collars 22, 24 prevent the tie-off structure 26 from being removed or coming off of post 12. In a typical configuration, a restraining device 30, such as a retractable lanyard for a harness, is connected to a harness (not shown) on a worker, and is secured to the tie-off structure 26, such as to an anchor structure 29 of the tie-off structure.

Any suitable restraining device 30 might be used with the invention. The tether 32 of the restraining device 30 is a retractable lifeline and generally remains tensioned by the restraining device 30. The tether 32, which may be made of Kevlar, a steel cable, or other suitable material, is typically wrapped around a braking mechanism (not shown) that is in the body 31 of the restraining device 30. The braking mechanism allows the tether 32 to spool out when there is a constant low force against the braking mechanism. Typically, the braking mechanism remains inactive when the person attached to the tether 32 is walking, working, or simply standing on the surface 18. The tether 32 will spool out and retract in the body 31, as the worker moves around and toward and away from the post. In the event that the tether 32 is spooled out quickly, such as when the person attached to the tether 32 falls from the elevated surface 18, the braking mechanism of the restraining device 30 will engage and stop further spooling of the tether. Generally, the braking mechanism might remain engaged until the restraining device is reset. The tie-off structure 26 holds or secures the restraining device to post 12. In this way, the invention and restraining device 30 may be used to arrest the fall of the person attached through the tether 32 and to prevent them from hitting the ground during a fall.

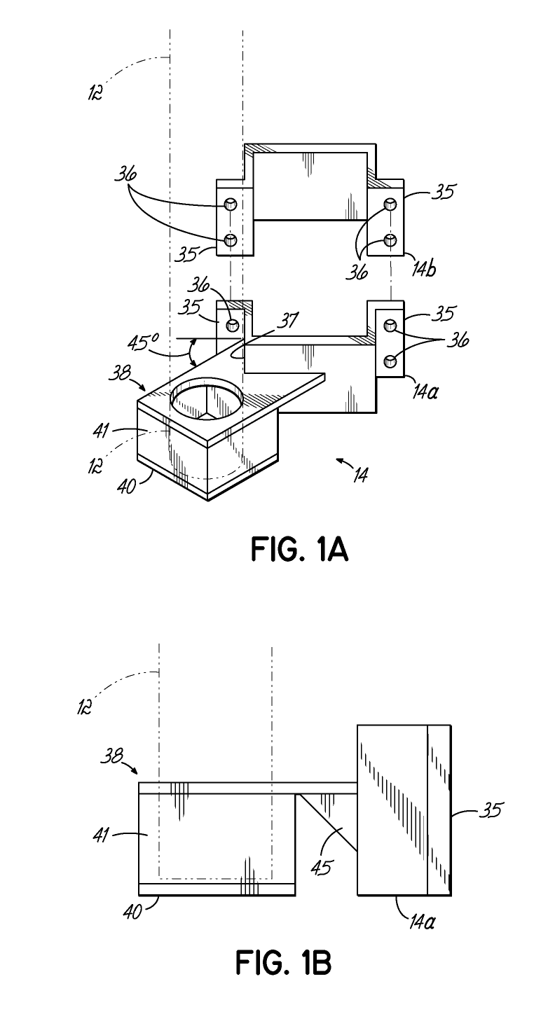

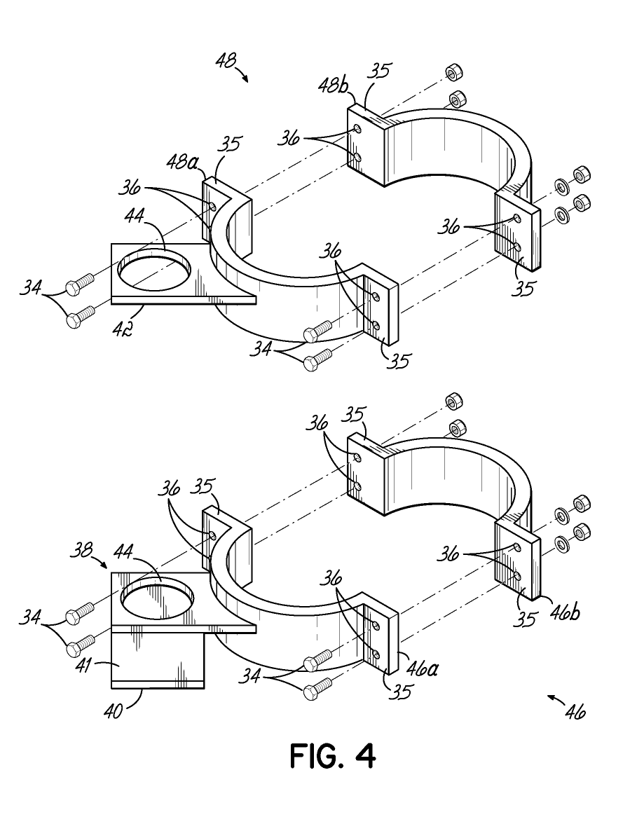

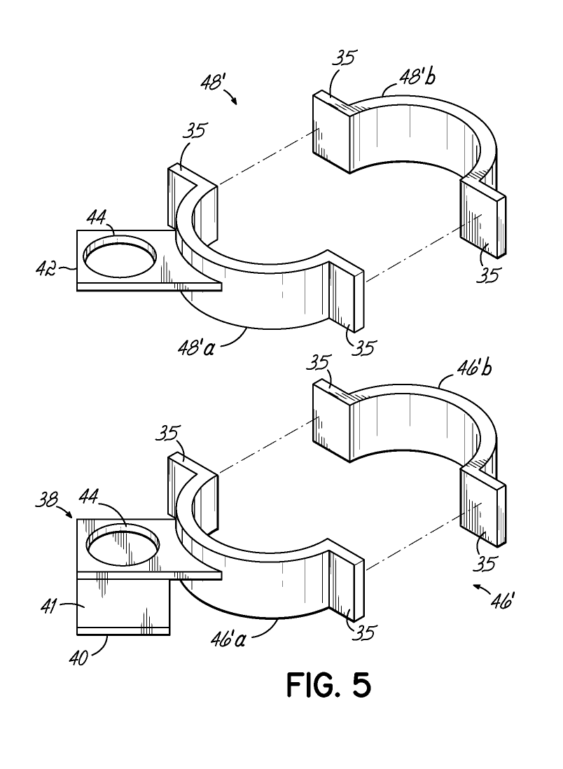

The various components of the fall protection device 10, as illustrated in FIG. 1, as well as other alternative embodiments are now described in greater detail. Turning to FIG. 2, the lower saddle 14 and the upper saddle 16, are illustrated in an exploded view, and removed from a column 20. In one embodiment of the invention, the upper saddle 16 includes the first saddle portion 14a, and a second saddle portion 14b that cooperate or come together to secure or couple the saddle to a column 20. In one particular embodiment, the first and second saddle portions 14a, 14b might be in the form of two similar halves of a clamshell design, where they are essentially identical halves that come together to surround and clamp onto a column 20, as illustrated in FIG. 1. The first and second saddle portions 14a, 14b of FIGS. 1-3 are constructed so that together they form a saddle having a generally rectangular cross-section to be secured to a square column, or beam with a similar rectangular cross-section. As may be appreciated, the first and second saddle portions 14a, 14b, are appropriately dimensioned for the particular column 20, with which they will be used. To secure the saddle portions 14a, 14b, as illustrated in FIG. 2, each portion might include tabs 35, or other suitable projections, which will come together when the portions are brought together, around the column. Suitable fasteners, such as bolts 34, pass through a plurality of openings or apertures 36, that are formed in the opposing saddle portions. In that way, each of the saddles 14, 16 might be secured to column 20, as illustrated in FIG. 1. The saddles 14, 16 might be configured in dimension for operating with typical 4″-10″ square or H-beam columns, or other sizes of columns. Similarly, the present invention might be utilized with other support structures, such as round columns, utilizing saddle embodiments, as illustrated in FIGS. 4 and 5, as discussed further herein below.

Each of the saddles includes a tongue portion, or tongue 38, 42, which extends or projects from a side of the respective saddle. Turning to the lower saddle 14, tongue 38 extends outwardly from the saddle, from a corner 37 of the rectangular saddle. In one particular embodiment, the tongue 38 extends at a 45° angle, with respect to a side of the rectangular cross-section of the saddle. Generally, within the building construction, a column will support one or more girders, which extend, end to end, between adjacent columns. Then, at right angles to the girders, other support structures, such as bar joists, extend. This forms a grid. By positioning the tongue 38 at a 45° angle with respect to the extension of the girders and the bar joists, the fall protection device of the invention will position the safety posts 12 so that it can extend up between any girders and joists of the grid to extend unhindered above work surface 18. As may be appreciated, other constructions with which the invention might be utilized might provide other orientations and arrangements for the support structures. Accordingly, the respective tongues 38,42 of the saddles might extend at other angles with respect to sides of the saddles, or the orientation of those saddles on the column 20. For round cross-section saddles, as in FIGS. 4 and 5, the saddles are rotated on the column to orient the tongues, as desired.

As illustrated in FIG. 2, the upper saddle 16 has a similar tongue 42, which is also oriented at 45° to be in alignment with tongue 38 on the lower saddle 14, when installed on a column. In one embodiment, an appropriate aperture or hole 44 is formed in each of the tongues 38, 42 for receiving the safety post 12. The apertures 44 are dimensioned to be larger than the diameter of the post 12 to readily and releaseably receive the post so that it is secured and supported between the saddles. The saddles are spaced apart on the column 20 a suitable distance for adequately supporting the safety post to insure that the safety post 12 can support the weight of a falling worker, and also to insure that the safety post does not readily come out of the saddles. For example, a spacing between the saddles in the range of 12″ to 14″ might be suitable for such purposes.

To further secure the safety post 12, the lower saddle 14 incorporates a stop wall 40 positioned and secured below the tongue 38 and aperture 44. A stop wall or stop structure 40 projects from the lower saddle 14 below tongue 38. The stop wall 40 may be part of a box structure 41, which is welded or otherwise secured to the tongue 38. In one embodiment, the stop wall 40 is positioned an appropriate distance below tongue 38 to securely hold the end 19 of the safety post. The end 19 of the post rests or abuts against the stop wall 40 of the saddle to thus form a base for the safety post 12, and to prevent its further travel through the saddles 16, 14. As may be appreciated, in installation, the saddles 14, 16 are installed at the appropriate positions near the top of the column 20. The safety post 12 may then be slid down to pass through the apertures 44 of the saddles, until the lower or bottom end 19 of post 12 abuts or rests against, or is seated against the stop wall 40. While a box-like structure 41 might be utilized for positioning the stop wall 40, other methods or structures might also be utilized to “stop” or seat the bottom end for support, as would be readily understood by a person of ordinary skill in the art.

The apertures 44 are appropriately sized depending upon the size of the safety post 12. Preferably, the apertures 44 are dimensioned so that there is not a significant amount of play or slop in the seated safety post, but the safety post may still be readily inserted into and removed from the saddles. This allows for strong support of the post, but also the convenience of moving a post around the work area.

In one embodiment of the invention, the saddles 14, 16 and their various components might be formed of a suitable mild steel. The tongues 38, 42 might be welded on the portions 14a, 16a of the saddles in the appropriate position, as discussed and illustrated. For the purposes of further strengthening the various saddles, and particularly the tongues, which will support the forces of the safety post, suitable stiffener structures 45, as illustrated in FIG. 1B, might be utilized to strengthen the respective tongues 38. Of course, as may be readily appreciated, other materials might also be utilized to form the saddles and their various components, as long as they have sufficient strength to support the safety post 12 and the weight of a worker who happens to fall while attached to the present invention.

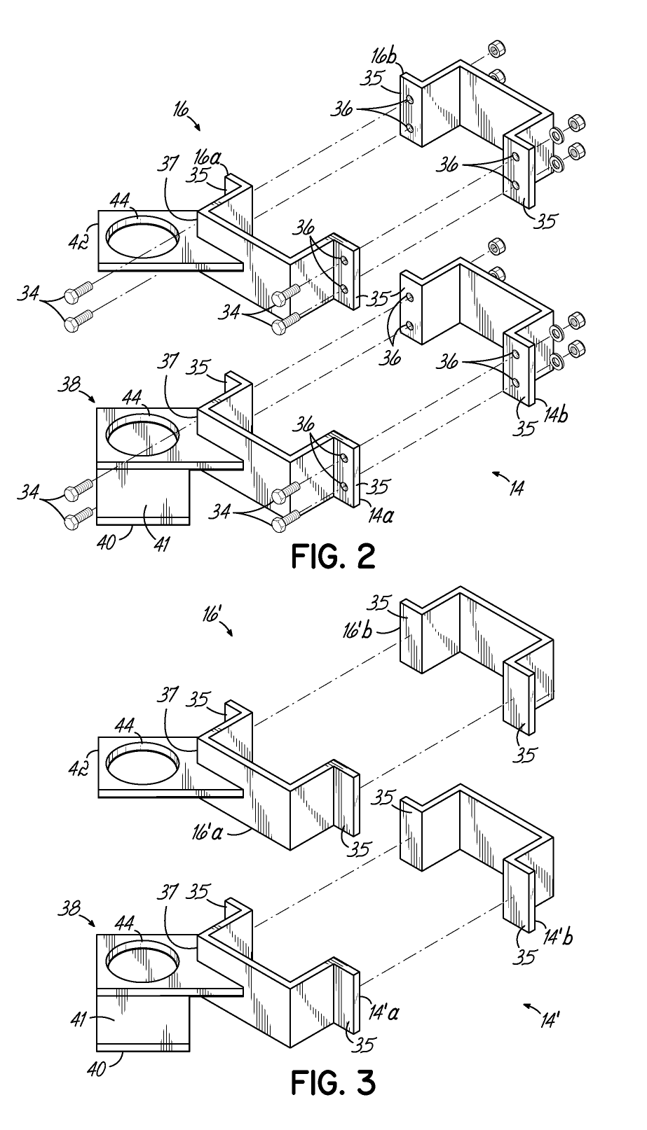

FIG. 3 illustrates alternative embodiments in the upper and lower saddles, which are indicated as 16′ and 14′. Rather than utilizing bolts, the halves or portions of the saddles 14′a, 14′b, and 16′a, 16′b might be welded together to couple to the column 20. Otherwise, they operate and are constructed similar to the saddles illustrated and discussed with respect to FIGS. 2 and 1A. As may be appreciated, other saddle structures with different securing methods might be used to support the posts. For example, the saddles might be strapped to a column with cords.

As noted above, the present invention, and particularly the upper and lower saddles 16, 14 might be configured for use with a column 20 having a rectangular cross-section. Alternatively, the column might be in the form a cylindrical pole, having a generally circular cross-section. To that end, an alternative embodiments to the invention as illustrated in FIGS. 4 and 5. The saddles 46, 48 might be configured to engage a cylindrical column. For example, as illustrated in FIG. 4, the lower saddle 46 and upper saddle 48 might include corresponding first and second portions 46a, 46b, and 48a, 48b which come together to encircle the column, and are held together by appropriate fasteners, such as bolts 34, passing through tab sections 35. The saddles 46, 48 utilize similar tongues 38, 42 with appropriate apertures 44 and a stop wall 40 for receiving and supporting the safety post 12. Similarly, FIG. 5 illustrates saddles 46′, 48′, which include portions 46′a, 46′b and 48′a, 48′b that come together to encircle and couple to a suitable column. The embodiments of FIG. 5 might be held together by welds between the adjacent tab sections 35 of each of the respective first and second saddle portions. Or the saddle portions might be strapped together, as noted above.

The safety post 12 may be fabricated out of a suitable material, such as schedule 40 metal pipe. In one embodiment, the safety post is around 6 to 8 feet long. While hollow pipe might be utilized, a solid pole or post might also be utilized in various different lengths for the invention.

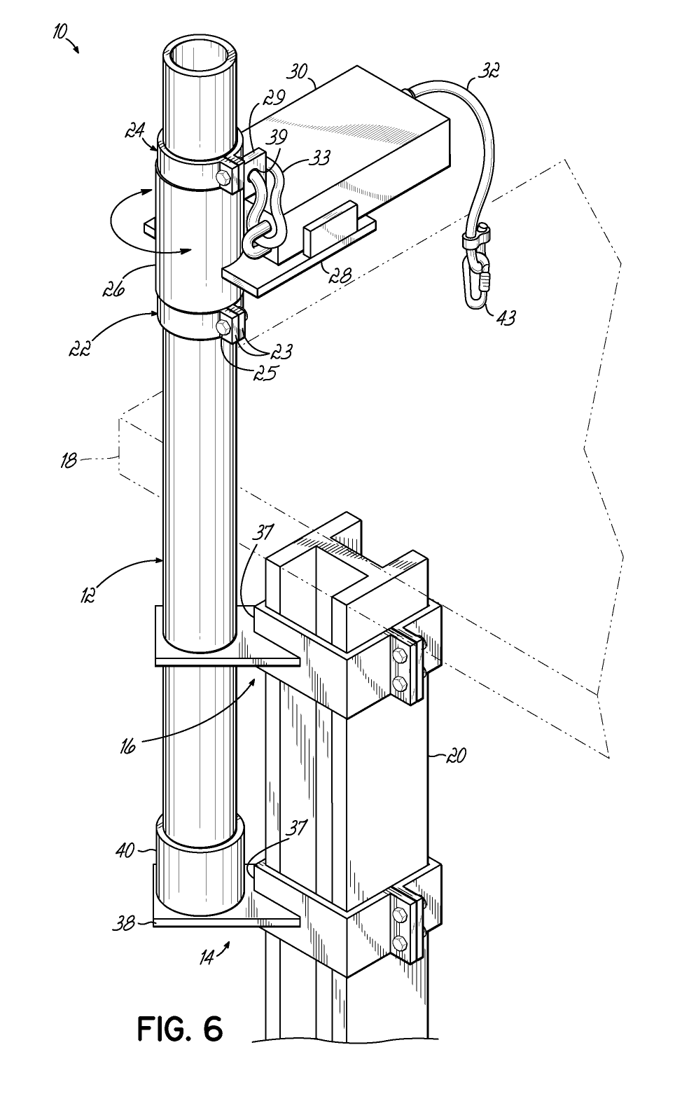

The support collars 22, 24 may also be formed of a suitable metal pipe, such as schedule 40 pipe, and are configured in diameter to be large enough to slide over the safety post 12, as shown in FIG. 1. The collars might include suitable threaded holes, such as for setscrews 21 to hold the collars in position on post 12. As illustrated in FIG. 6 showing an alternative embodiment of the invention, the collars 22, 24 might also be in the form of a metal band that is wrapped around safety post 12, which includes opposing tab sections 23 that are secured together with a bolt or other fastener 25 to secure the collars at the proper position on the safety post 12. The collars could be secured in other ways as well.

The rotatable tie-off structure 26 for the restraining device 30 includes a collar portion 27, which is generally cylindrical in shape, and can also be made out of a suitable length of pipe, such as schedule 40 pipe. The dimensions of the collar portion 27 are such that it fits over, and rotates freely, around the safety post 12 between collars 22, 24. A platform portion 28 is coupled to the collar portion 27, and extends outwardly from collar portion 27 to receive and support the restraining device. For example, a restraining device 30, such as a retractable lanyard, will include a body 31 that may lie on the platform portion 28 for support. The rotatable tie-off structure 26 also includes an anchor structure 29, which is securely fixed to the tie-off structure, such as to the collar portion 27. The anchor structure 29 may be secured to the restraining device 30, such as with a cable 33, or other suitable structure. For example, in the embodiment illustrated in FIG. 1, cable 33 extends between the body 31 of the restraining device 30, and a suitable hole or aperture 39 formed in the anchor structure of the tie-off portion. Platform portion 28 and anchor structure 29 may be suitably fixed to collar portion 27, such as by welding or other suitable means, such as bolts (not shown). Such portions or structures 28, 29 might be formed of a suitable metal, which is readily welded to the collar portion 27. Platform portion 28 may have a suitable radius cut formed therein so that it partially surrounds the collar portion 27, as illustrated in FIG. 1. Platform portion also includes side tabs, which hold the restraining device 30 on the platform portion 28. Furthermore, if additional securement is desired, suitable straps or bungee cords (not shown) might be wrapped around the body of the restraining device to further secure it to the platform portion 28. Accordingly, the restraining device 30 is anchored, and freely rotates around the safety post 12 to allow a worker significant freedom of movement. The tether 32, which spools out from the restraining device, and is appropriately retracted, therefore allows the worker to work in a suitable circular area around the safety post, as dictated by the length of the tether. The tether 32 might also include a clip 43, such as to clip to the safety harness of a worker. In that way, if the safety worker falls, they will be supported by tie-off structure 26 and post 12, to which the restraining device 30 is secured.

In FIGS. 1-5, the saddle 14 is illustrated with a tongue 38, and incorporates a stop wall 40 positioned below the tongue. In that way, the safety post is inserted through the aperture 44 of tongue 38, until it abuts or rests against the stop wall 40. In an alternative embodiment, as illustrated in FIG. 6, the tongue 38 might provide the stop wall. In such an embodiment, a sleeve structure or sleeve 40 is coupled with the tongue 38, such as by welding. The sleeve structure 40, which may also be a section of schedule 40 pipe, is sized sufficiently to receive the end 19 of the safety post 12. The sleeve sits on top of the tongue 38, wherein the tongue then provides a stop wall. Therefore, the safety post 12 is inserted through saddle 16, and into the sleeve structure 40 until it hits or abuts against tongue 38. In such a scenario, obviously, the aperture 44 is not formed in the tongue 38.

In operation, a fall protection device consistent with the disclosed embodiments of the invention may be installed on support columns that do not extend through a surface 18, or roof surface. In this way, the saddles are attached to the support column (i.e., a square cross-section support column or a round cross-section support column) to support a post 12 beneath a surface 18. As such, the post 12 may be quickly installed into the saddle set and a worker might attach their restraining device 30 to the tie-off structure 26 proximate the top of the post. As the person moves about the surface 18, the tie-off structure 26 rotates to follow the position of the person and the tether 32 spools from the restraining device 30. When the person falls from the surface 18 the saddle set prevents the post 12 from being removed and otherwise “anchors” the post 12. The post 12, thus anchored, holds the weight of the worker. The platform portion 28 of the support structure 26 supports the restraining device 30, which is also secured to anchor structure 29. The device 30 engages the braking mechanism (not shown) attached to the tether 32 to arrest the fall of the person.

In the embodiment of the invention illustrated in FIGS. 1-6, the saddles 14, 16 are coupled to a support column. As the person moves around, the saddles might be detached and moved to different support columns throughout the work area. Alternatively, multiple sets of saddles 14, 16 might be utilized, and a worker merely has to move the pole from one set of saddles to another set of saddles. Ultimately, when the job is completed, all the saddles may then be removed from the various support columns.

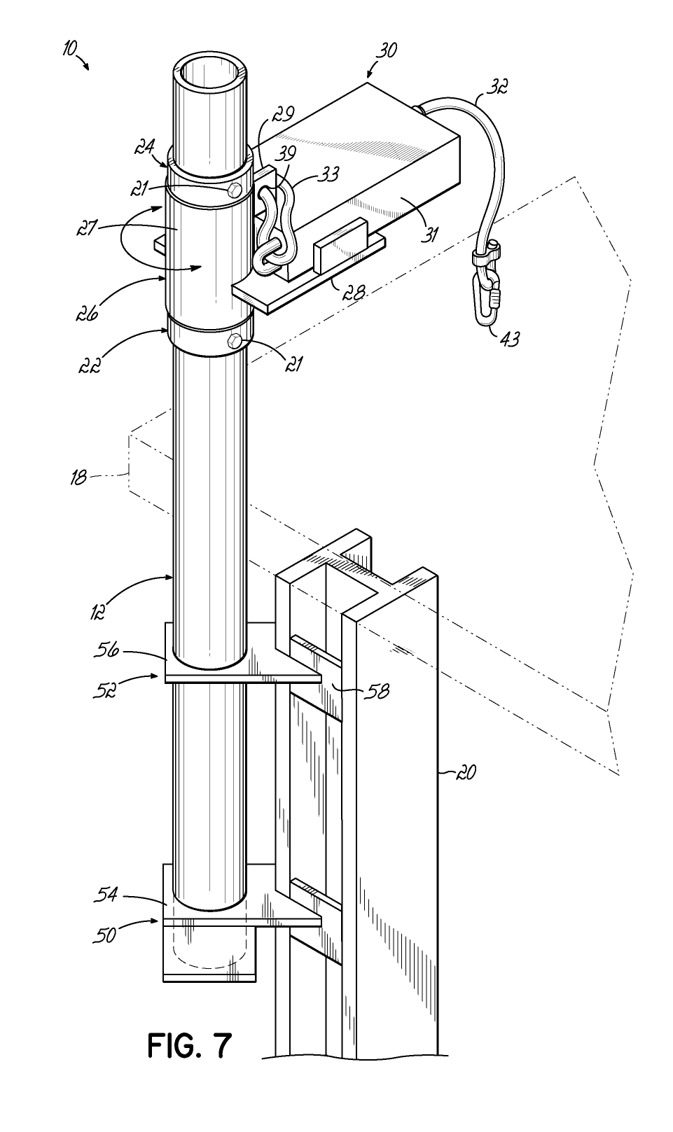

In an alternative embodiment of the invention, the saddles might be permanently fixed to all of the columns used in the construction of the building. In that way, the step of installing the saddles on certain of the columns is eliminated. When the construction is complete, the safety post and the support structure, which holds the restraining device 30, are simply removed. The saddles remain in place. Because of the relative small size of the saddles in relation to the overall construction, and also their positioning above the ground surface and close to the roof, they might remain in position on the tops of the columns, without drawing significant attention or degrading the aesthetic appearance of the construction. For example, as illustrated in FIG. 7, alternative saddle structures 50, 52 are shown permanently affixed to a support column 20. For example, the respective tongues or tongue portions 54, 56 might be permanently affixed to support column 20, such as by welding. While the support column 20 may provide one surface for welding, an alternative plate 58 might be incorporated between sections of a support column 20, such as an H-beam in order to provide a further surface for securing the tongues 54, 56. A solid, square beam may not use such a plate 58, and the tongue portions 54, 56 are fixed right to the beam sides. The saddles 50, 52 might then operate similar to those saddles illustrated in FIG. 1 and other of the figures herein. Alternatively, the saddles that are permanently welded to the column might also resemble an alternative embodiment, as illustrated in FIG. 6. The columns 20 might be originally formed with such saddles 54, 56, or the saddles might be welded to the columns at the work site. Also, while rectangular columns are shown in FIG. 7, cylindrical columns might be used with the permanent saddles 50, 52, as understood according to the inventor as disclosed.

The invention provides a fall protection device that can be moved easily, yet provides significant safety when a person is attached. When the person desires to move to a different portion of the surface 18, they may remove the post 12 and transport it to a separate saddle set installed on a separate support column. In this way, the person can install the post 12 into that separate saddle set to access the different portions of the surface 18. Once all work is done on the surface 18, each post may be removed, and the saddles may be removed or remain on the support columns.

While the present invention has been illustrated by a description of the various embodiments, and while these embodiments have been described in considerable detail, it is not the intention of the applicants to restrict or in any way limit the scope of the appended claims to such detail. Additional advantages and modifications will readily appear to those skilled in the art. Thus, the invention in its broader aspects is therefore not limited to the specific details, and representative device and methods shown and described. Accordingly, departures may be made from such details without departing from the spirit or scope of applicants' general inventive concept.

What is claimed is:

1. A fall protection device for protecting a person from a fall from a surface, comprising:
a lower saddle configured for coupling to a column, the lower saddle including a tongue projecting from a side thereof and a stop wall projecting from the lower saddle below the tongue, an aperture being formed in the tongue;
an upper saddle configured for coupling to a column above the lower saddle, the upper saddle including a tongue projecting from a side thereof and an aperture formed in the tongue;
an elongated safety post having an upper and lower end, the post configured for removably engaging the saddles by passing through the apertures of both the upper and lower saddles so the lower end of the post rests against the stop structure;
a tie-off structure mounted on the upper end of the post; the tie-off structure configured to rotate around the upper end of the post, and including a platform portion for supporting a restraining device coupled to a worker.

2. The fall protection device of claim 1 wherein at least one of the saddles includes a first portion and a second portion configured to come together and surround a column to couple to the column.

3. The fall protection device of claim 1 wherein the at least one saddle includes two halves that come together in a clamshell fashion to couple to the column.

4. The fall protection device of claim 1 wherein the saddles are configured to couple with a column having a square or round cross section.

5. The fall protection device of claim 1, the tongue of at least one of the saddles projects from a side of the saddle at a 45° angle with respect to the side of the saddle.

6. The fall protection device of claim 1 wherein the tie-off structure includes a collar portion to surround and rotate around the safety post.

7. The fall protection device of claim 6 wherein the tie-off structure includes a anchor structure coupled to the collar portion for anchoring a restraining device coupled to the worker.

8. The fall protection device of claim 1 further comprising collars positioned above and below the tie-off structure to position and secure the tie-off structure on the safety post.

9. A fall protection device for protecting a person from a fall from a surface, comprising:
a lower saddle configured for coupling to a column, the lower saddle including a tongue projecting from a side thereof and a sleeve structure on top of the tongue;
an upper saddle configured for coupling to a column above the lower saddle, the upper saddle including a tongue projecting from a side thereof and an aperture formed in the tongue;
an elongated safety post having an upper and lower end, the post configured for removably engaging the saddles by passing through the aperture of the upper saddle so the lower end of the post rests in the cup structure;
a tie-off structure mounted on the upper end of the post; the tie-off structure configured to rotate around the upper end of the post, and including a platform portion for supporting a restraining device coupled to a worker.

10. The fall protection device of claim 9 wherein at least one of the saddles includes a first portion and a second portion configured to come together and surround a column to couple to the column.

11. The fall protection device of claim 9 wherein the at least one saddle includes two halves that come together in a clamshell fashion to couple to the column.

12. The fall protection device of claim 9 wherein the saddles are configured to couple with a column having a square or round cross section.

13. The fall protection device of claim 9, the tongue of at least one of the saddles projects from a side of the saddle at a 45° angle with respect to the side of the saddle.

14. The fall protection device of claim 9 wherein the tie-off structure includes a collar portion to surround and rotate around the safety post.

15. The fall protection device of claim 6 wherein the tie-off structure includes an anchor structure coupled to the collar portion for anchoring a restraining device coupled to the worker.

16. The fall protection device of claim 1 further comprising collars positioned above and below the tie-off structure to position and secure the tie-off structure on the safety post.

17. A fall protection device for protecting a person from a fall from a surface, comprising:
a column for supporting a portion of a building including a lower saddle structure positioned proximate one end of the column and an upper saddle structure positioned above the lower saddle;
each of the saddle structures including a tongue projecting from a side of the column and an aperture being formed in each tongue;
the lower saddle structure including a stop wall positioned below the tongue of the lower saddle structure;
an elongated safety post having an upper and lower end, the post configured for removably engaging the saddles by passing through the apertures of both the upper and lower saddles so the lower end of the post rests against the stop structure;
a tie-off structure mounted on the upper end of the post; the tie-off structure configured to rotate around the upper end of the post, and including a platform portion for supporting a restraining device coupled to a worker.
